(19) United States
(12) Patent Application Publication
(10) Pub. No.: US 2026/0235249 A1
(43) Pub. Date: Aug. 13, 2026

(54) LUMEN NETWORK INSPECTION ROBOT

(71) Applicant: The Regents of the University of California, Oakland, CA (US)

(72) Inventors: Thomas R. Bewley, Julian, CA (US); Joonyoung Jang, Yuseong-gu, Daejeon (KR); Tao-yi Wan, San Diego, CA (US); Zachary Hooker, Gold River, CA (US); Pablo Tejeda, San Diego, CA (US)

(21) Appl. No.: 19/147,834

(22) PCT Filed: Jan. 18, 2024
(86) PCT No.: PCT/US2024/011934

§ 371 Date: Jul. 14, 2025

Related U.S. Application Data
(60) Provisional application No. 63/480,624, filed on Jan. 19, 2023.
(60) Provisional application No. 63/494,501, filed on Apr. 6, 2023.

(51) Int. Cl. F16L 55/32; F16L 55/40

(52) U.S. Cl. CPC F16L 55/32; F16L 55/40

(57) ABSTRACT

A lumen network inspection robot includes at least two drive wheels configured to propel the robot in an axial direction of the lumen. At least one control wheel is configured to control roll of the robot around an axial centerline of the lumen. One or more motors are arranged to drive the at least two drive wheels. A body structure includes one or more arms supporting the at least two drive wheels and the at least one control wheel. Bias elements bias the at least two drive wheels and the at least one control wheel toward contact with at least three alternating points on a wall of the lumen. Control electronics are configured to control the one or more motors. The robot includes one or more sensors. Rotational centers of the at least two drive wheels and the at least one control wheel lie in a common plane.

### PRIORITY CLAIM AND REFERENCE TO RELATED APPLICATION

The application claims priority under 35 U.S.C. § 119 and all applicable statutes and treaties from prior United States provisional application Ser. No. 63/480,624, which was filed Jan. 19, 2023, and from prior U.S. provisional application Ser. No. 63/494,501, which was filed Apr. 6, 2023.

### FIELD

A field of the invention is lumen network inspection, including pipe and duct networks. A pipe or duct network can be straight sections of water or gas pipes having tube shape, as well as HVAC system ducts, of nominally circular cross section. Such networks include elbows that change the lumen direction, joints that connect three or more sections, and reducers that change the nominal lumen diameter. Example applications of the invention include inspection of natural gas pipe networks and water pipe networks.

### BACKGROUND

Pipe networks may be filled with a gas such as compressed air, nitrogen, steam, or natural gas or a liquid (such as water or oil) during the inspection process, which might be flowing down the pipe. Gas-filled pipe networks might have puddles of water or mud. The walls of the pipes may be irregular, with fasteners protruding into the pipe, and/or grooves or lips where pipe sections are joined together, especially at pipe valves that may be used at times to stop the flow of the gas or liquid in the pipe. The pipes of interest may be old and corroded. Large portions of such pipe networks are often essentially inaccessible externally, being buried underground or under a seabed, or behind walls, ceilings, and/or floors in buildings, refineries, or large ships. Sections of pipes in such networks may be horizontal, vertical, or at other slopes with respect to gravity. Duct networks are similarly found behind walls, under floors and ceilings and other generally difficult to access locations.

Snake or serpentine robots have been proposed to inspect lumens, such as the pipe and duct networks discussed in the previous paragraph. U.S. Pat. No. 9,796,081 describes a snake robot with segments and friction anchors. The friction anchors are brought into and out of contact with a lumen wall to provide a push-pull effect to generate snake-like movement. U.S. Pat. No. 9,031,698 describes a robotic crawler that uses a drive linkage/belt. These types of robots encounter substantial frication and require complex power-hungry movements to navigate in lumens.

U.S. Pat. No. 8,464,642 describes a self-orienting, two-wheel pipe crawler, which is configured to convey payload through a pipe, and automatically self-stabilize and orient itself inside the pipe. The crawler includes two pipe tracking contactors that maintain contact between the pipe tracking contactors and the pipe wall and maintain the apparatus in a functional orientation. This and other similar designs require control feedback from a suite of functioning sensors simply to keep from falling, require a complex mechanism and maneuver to right themselves from a fall, and to right themselves into driving orientation when initially lowered into a pipe, and require a reaction wheel of significant mass in order to provide substantial pitch control to negotiate joints.

Kakogawa and Ma, “Design of a Multilink-Articulated Wheeled Pipeline Inspection Robot Using Only Passive Elastic Joints,” Advanced Robotics, Vol. 32, No. 1, pp. 37-50 (2018) describes a multilink-articulated robot with omni and hemispherical wheels for inspecting and exploring pipelines. This design is an advance toward lumen inspection robots but has a profile with wheels in many different planes, including multiple omni wheels and hemispherical wheels in different planes. This does not allow the robot to form a planar arrangement and limits its ability to be sized to inspect small pipes, e.g., four-or two-inch diameter pipes.

### SUMMARY OF THE INVENTION

A preferred embodiment provides a lumen network inspection robot that includes at least two drive wheels configured to propel the robot in an axial direction of the lumen. At least one control wheel is configured to control roll of the robot around an axial centerline of the lumen. One or more motors are arranged to drive the at least two drive wheels. A body structure includes one or more arms supporting the at least two drive wheels and the at least one control wheel. Bias elements bias the at least two drive wheels and the at least one control wheel toward contact with at least three alternating points on a wall of the lumen. Control electronics are configured to control the one or more motors. The robot includes one or more sensors. Rotational centers of the at least two drive wheels and the at least one control wheel lie in a common plane.

### BRIEF DESCRIPTION OF THE DRAWINGS

FIGS. 1A-1H show a preferred lumen inspection robot;

FIGS. 2A-2D show the robot of FIGS. 1A-1H in two differently sized lumens;

FIGS. 3A-3I show the robot of FIGS. 1A-1H navigating from a primary lumen to a branch lumen;

FIG. 4 shows another operational state of the robot of FIGS. 1A-1H in which one of the control wheels is out of contact with the lumen wall;

FIGS. 5A and 5B show another preferred lumen inspection robot with central and arm articulation joints;

FIGS. 6A-6B show a variation of the robot of FIGS. 5A and 5B;

FIG. 7 illustrates an articulation joint of the robots of FIGS. 5A-5B and 6A-6B;

FIGS. 8A-8C show a robot 800 that is similar to the robot of FIGS. 1A-1H but has vertically oriented control wheels;

FIGS. 9A-9E show another robot similar to the of FIGS. 1A-1H but using a different type of frame and different type of wheels;

FIGS. 10A-10C show another robot similar to the robot of FIGS. 1A-1H with a central drive wheel concentric with a central articulation; and

FIGS. 11A-B show a generally cylindrical transport module for the robot of FIGS. 10A-10C.

### DETAILED DESCRIPTION OF THE PREFERRED EMBODIMENTS

Preferred embodiment lumen network inspection robots can carry sensors on their body sections such as sensors for optical, acoustic, percussive, and/or electrical testing of lumen wall integrity. The body sections can also carry wireless communication circuitry and hardware to communicate with an external device and/or electronics for data collection from on-board sensors. The preferred robots can be sized according to a particular inspection task, while features of the preferred robots permit a single robot to be used with a substantial range of lumen sizes, for example from a minimum diameter lumen size to 2×, 3× or more of the minimum size. The minimum diameter is limited essentially by the diameter of wheels, as the robots can attain a position that is slightly larger than the diameter of drive and control wheels.

Preferred lumen network inspection robots can traverse networks of pipes or ducts with numerous elbows, joints, and/or diameter changes, for tasks including internal inspection, exploration, and mapping. The robots have three or more wheels, whose center points all intersect a center plane of the robot, which allows for minimum friction and interference with a surrounding lumen wall, its imperfections, and impediments in the lumen, including changes in diameter, curves and turns.

The present robots have minimal complexity, maximal maneuverability, static stability, and fault tolerance. Passive features bias the robots to a stable position within a lumen, such that no power is needed for the robot to maintain stationary. Preferred robots include active control of roll, and passive tension features to urge the three or more wheels against three or more different points of the lumen wall, which points are axially distal from one another. A rotational plane of at least one of the wheels is perpendicular to the rotational plane of the other two wheels. Preferred robots include articulated joints in a frame permit the robot to have a stable orientation in pitch and yaw, allowing the robot to travel stably within a pipe at any orientation with respect to gravity without feedback and to travel in the lumen through straight portions, curved portions, elbows, joints, and substantial diameter changes.

Preferred robots are self-propelled and can be accurately controlled for roll about a lumen centerline. Spring bias features integrated with servo motors always provide stability in pitch and yaw during normal operations, even when maneuvering through complex networks of connected pipes with elbows, joints, and significant diameter changes. Fault tolerance is provided in that one of the robot's control and drive wheels can fail while the robot still maintains the ability to navigate a lumen or exit the lumen without need for retrieval. Preferred robots are “planar”, meaning that rotational center points of all wheels on the robot lie in essentially the same plane. As a result, these robots have reduced cross-sectional blockage as compared to nonplanar pipe robot designs (with approximately the same size motors and wheels) that span the width of the pipe, when put in the same size pipe. In all positions of preferred robots, including during roll and turning operations, a centerline of the robots remains aligned with a plane that passes through a central axis of the lumen.

A preferred robot for traversing individual pipes or ducts of nearly circular cross sectional profile (hereafter referred to simply as pipes), and/or for traversing networks of such pipes with numerous pipe elbows and/or pipe joints and/or pipe diameter changes, includes 3 or more robot wheels, the center points of which all lie essentially within the same plane and has motors, sensor and passive bias elements to propel itself along the pipe, and controlling itself in roll about the centerline of the pipe. Spring biased arm control assemblies maintain at least robot wheels at 3 or more alternating points of contact against opposite sides of the pipe and stabilized the robot orientation in both pitch and yaw thus allowing the robot to travel stably (i.e., without control feedback) within a pipe at any orientation with respect to the direction of gravity.

In preferred embodiments, one or more of drive wheels oriented such that the axles are nominally perpendicular to a center plane of the robot, akin to the orientation of the wheels of a bicycle, and are driven by one or more electric motor(s), either directly (e.g., via a hub motor, as on an electric scooter) or indirectly (e.g., with a system of belts and pulleys or meshed gears to a motor mounted near the wheels. One or more control wheels are preferably omni wheels and are oriented with their axles aligned in a direction nominally orthogonal to the axles of the drive wheels, but not necessarily parallel to the centerline of the pipe.

Preferred embodiments include one or more rotary articulations, between two or more distinct robot body and/or arm sections. The rotary articulations are constrained to maintain all the robot wheels essentially within the robot center plane, and the rotary articulations are driven by springs and/or servos (or motors with position feedback acting like servos), to press robot wheels at 3 or more alternating points of contact against opposite sides of the pipe wall.

Preferred robots can include navigation and environment sensors that allow the robots to actively control themselves in roll maneuvers coordinated using feedback from sensors on the robot such that, when approaching debris or a puddle of fluid in the bottom of the pipe, the robot is first rolled, before reaching the debris or puddle of fluid, such that the robot center plane is oriented nearly horizontally with respect to the obstacle, thus passing safely over the debris or puddle of fluid.

Sensors and electronics on the robot can also conduct maneuvers when approaching an upcoming pipe elbow or pipe joint, such that the robot is first rolled, before reaching the pipe elbow or pipe joint, such that the robot center plane coincides with the plane containing the (curved) centerline of the pipe elbow, or with the path to be followed when turning from the entering section of pipe into the exiting section of pipe when taking the desired branch at the pipe joint. An attached tether can be used, with the tether carrying electric power, and/or signals to and from the robot to perform remote control. The sensors and electronics can include a battery, and wireless communications, such as through radio or acoustic signals to permit remote control. The sensors and electronics can also be configured to allow autonomous operation for extended periods of time using logic preprogrammed on an onboard microcontroller.

Preferred embodiments of the invention will now be discussed with respect to experiments and drawings. Broader aspects of the invention will be understood by artisans in view of the general knowledge in the art and the description of the experiments that follows.

Artisans will notice in all of the preferred embodiments, that rotational centers of the drive wheels and control wheels lie in essentially the same plane. A straight line can be drawn through the rotational center of all drive wheels and control wheels, even though the control wheels rotate in different planes than the drive wheels. In addition, that same line is preferably a center of the robot body.

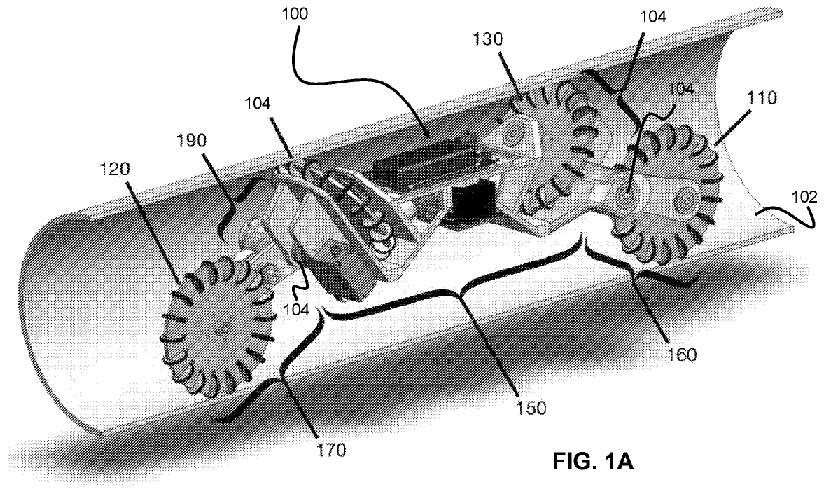

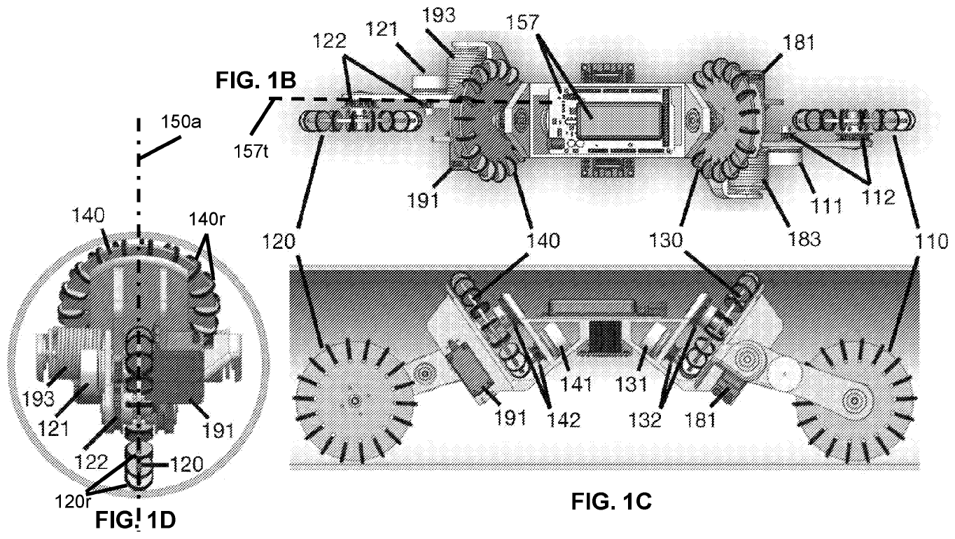

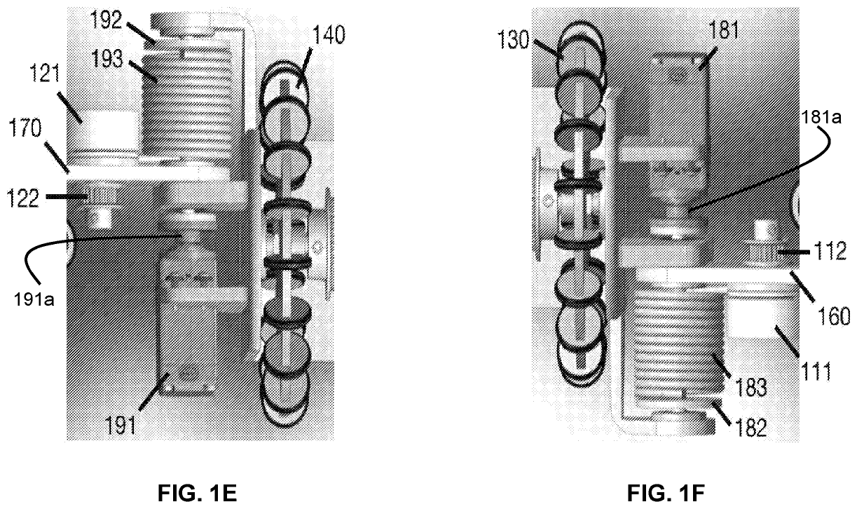

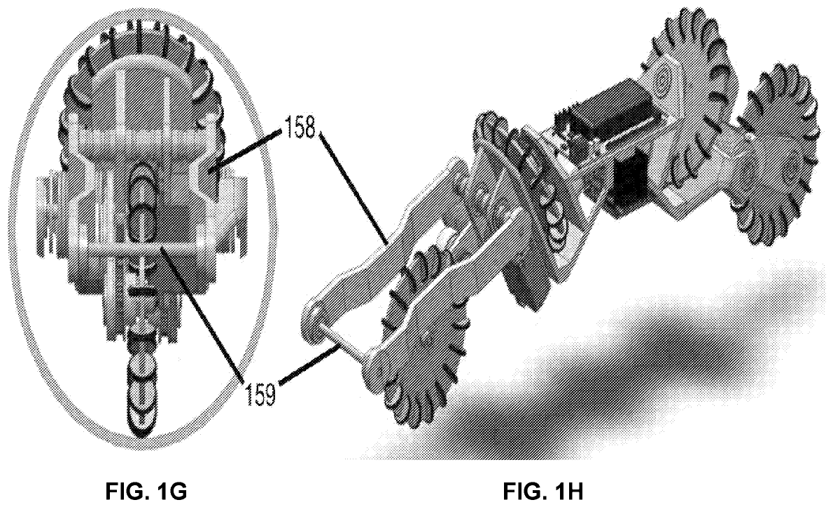

FIGS. 1A-1H show a preferred lumen inspection robot 100. With reference to FIG. 1A, the robot is shown in a lumen defined by a pipe or duct wall 102 and contacts the lumen wall 102 with four wheels 110, 120, 130, and 140. The wheels are tensioned to press against the wall 102 at different axial locations by elastic actuators 104 that keep all four wheels 110, 120, 130, and 140 pressed against the lumen wall in straight sections, and at least three of the wheels when the robot is traversing curves, bends and changes of diameter of the lumen.

The robot 100 is a three-segment vehicle, consisting of two robot arms 160 and 170 rotationally mounted to a shaped robot frame 150. The wheels 110 and 120 are drive wheels and are mounted at distal ends of the robot arms 160 and 170. The wheels 130 and 140 are control wheels and are mounted to the frame 150 with their rotational planes preferably angled away from one another, and with each rotational plane being orthogonal to a rotational plane of one of the drive wheels 110 and 120. The control wheels serve 130 and 140 to accurately control the roll of the vehicle about an axial centerline of the lumen. The control wheels 130 and 140 are preferably canted outward by an angle phi from a vertical plane that passes through the axial center line of the lumen (e.g., between 5 and 45 degrees). A preferred angle phi is ~35 degrees. Center points of the drive wheels 110 and 130 and the control wheels 130 and 140 lie in essentially the same plane. A straight line would be drawn through the center of all four wheels 110, 120, 130 and 140.

The frame 150 has a general C-shaped profile. Elastic actuators 104 bias the arms 160 and 170 such that at all times, contact between at least one of the drive wheels 110 and 120 and at least one of the control wheels 130 and 140 with the lumen wall 102 is made at two, three or four alternating points of contact. Contact of at least one drive wheel and at least one control wheel is maintained even when the robot travels through curves, substantial lumen diameter changes, or into a branch at a pipe joint, regardless of the orientation of the pipe with respect to gravity.

FIGS. 1B-1H show different full and partial view to illustrate details of the robot 100. Best seen in FIG. 1B, are drive wheel servo motors 111 and 121 that drive the respective drive wheels 110 and 120 through respective belt/toothed pulleys 112 and 122. Control wheel servo motors 131 and 141 that drive the respective control wheels 130 and 140 through respective belt/ toothed pulleys 132 and 142. The drive wheels 110 and 120 provide movement in the direction of a lumen axis, while the control wheels 130 and 140 can roll the robot 110 over a full 360 degrees within the lumen. The frame 150 in its central portion includes a mounting platform that holds an electronics and battery module 157. Wiring to and from the electronics and battery module 157 and the various motors is omitted for clarity of illustration and can be connected in any conventional manner along the body 150 and arms 160 and 170. Shown in FIGS. 1G and 1H are an optional trailer hitch 158 and an attachment bar 159 that permit the robot 100 to tow or push additional devices, such as additional sensors, batteries, marsupial robots, repair devices (such as epoxy spray coating devices that can close small holes in the lumen). The hitch and bar are wide and rigid, such that an attached device can roll around the centerline axis of the lumen with the robot body 150.

FIG. 1B shows that a tether 157t can be routed to the electronics 157, preferably in a plane offset from the rotation of drive wheel 120 and be attached at any non-interfering location along the arm 190 and frame 150. The tether 157t can carry power as well as control/communications with the robot, and then the electronics 157 does not need to include a battery. The sensors and electronics 157 can instead include a battery, and wireless communications, such as through radio or acoustic signals to permit remote control. The sensors and electronics 157 can also be configured to allow operating autonomously for extended periods of time using logic preprogrammed on an onboard microcontroller.

With reference again to FIGS. 1B-1F, and particularly FIG. 1F, a servo motor 181 drives the elastic series actuator 104 that controls the arm 160 of the drive wheel 110. An output plate 182 is rotationally driven by a shaft 181a. A coil spring 183 connects the output plate to the arm 160. With reference to FIG. 1G, a servo motor 191 drives the elastic series actuator 104 that controls the arm 170 of the drive wheel 120. An output plate 192 is rotationally driven by a shaft 191a. A coil spring 193 connects the output plate to the arm 170. While elastic series actuators 104 that use springs are used in a preferred embodiment, servo motors without the springs can be used with appropriate force feedback. The extended output shafts 181a and 191a are directed through the center of the springs 183 and 193, and drive the rotation of plates 182 and 192. Output plates 182 and 192, in turn, attached to springs 183 and 193, which then connect back to drive the rotation of robot arms 160 and 170.

FIG. 1D shows that rotational centers of the drive wheels 110 and 120 and control wheels 130 and 140 lie in a common plane 150a. That common plane 150a is through the rotational center of all drive wheels and control wheels, even though the control wheels rotate in different planes than the drive wheels. In addition, that same plane is through a center of the robot body 150.

As best seen in FIG. 1D, the drive and control wheels preferably include a plurality of rotatable rings, e.g. as labelled 120r and 140r in FIG. 1D. The rings 120r and 140r (included but not labelled on all drive and control wheels) have a rubber or polymer grip surface and rotate in holes near an out circumference of a respective wheel to permit easy rotation of the robot 100 in a direction perpendicular to the radius of the respective wheel. In other words, during linear motion via the drive wheels 110 and 120, rings on the control wheels 130 and 140 that are in contact with the lumen wall freely rotate such that there is little to no resistance to linear travel. When the control wheels rotate the robot about a linear axis of the lumen, rings on the drive wheel ensure that there is little or no resistance to rotation of the robot. The rings make the drive wheels 110 and 120 and the control wheels 130 and 140 omni wheels, i.e. the wheels allow easy movement in a direction parallel to their central axis of rotation.

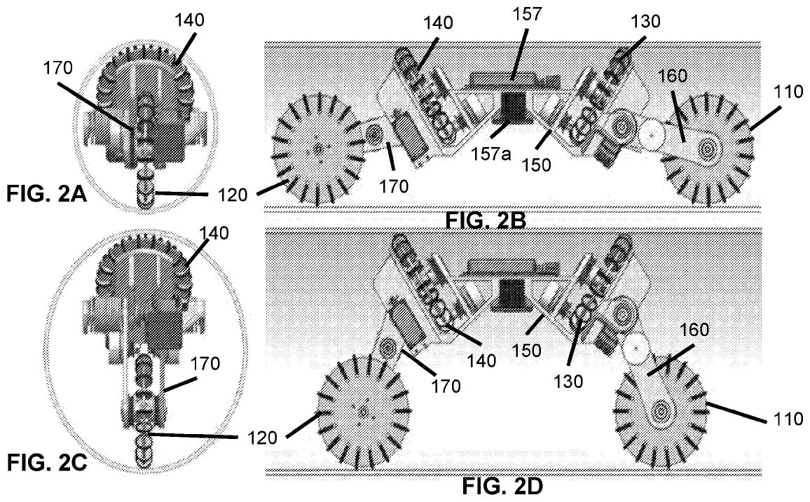

FIGS. 2A-2D show the robot 100 in two different lumens, a lumen with a smaller diameter (FIGS. 2A-2B) and a lumen with a larger diameter (FIGS. 2C-D). The robot 100 lengthens (distance from drive wheel 110 to drive wheel 120) and lowers the body 150 and control wheels 130 and 140 via reducing an angle of the arms 160 and 170 with respect to the body when in the smaller diameter lumen in FIGS. 2A-2B. The robot 100 shortens (distance from drive wheel 110 to drive wheel 120) and raises the body 150 and control wheels 130 and 140 via increasing an angle of the arms 160 and 170 with respect to the body 150 when in the larger diameter lumen in FIGS. 2C-2D. All of the wheels are planar, as discussed above.

FIGS. 2A-2D also show that the body 150 can carry a sensor 157a that is controlled, powered and used by the electronics and battery 157 for lumen inspection. The sensor 157a can be an image sensor and lens, for example, or can include additional or alternate sensors, such as humidity, temperature, gas detectors, etc. The sensors 157a can also include sensors for navigation of the robot and for avoiding impediments, e.g., when the sensors detect that the robot is approaching debris or a puddle of fluid settled into the bottom of a pipe, the control wheels 130 and 140 can be used to roll the robot, before reaching the debris or puddle, such that the middle part of the frame is oriented nearly horizontally, thus passing safely (and, stably, in a manner not requiring feedback) over the debris or puddle. Navigation sensors can include wheel odometers on the drive wheels, which can be used to estimate the distance travelled down pipe. LiDAR-based visual odometry is preferred to eliminate errors related to wheel slippage. For pipe sections that are not vertical, an inertial measurement unit (IMU) can be included in the electronics and battery 157 to provide roll angle of the robot within the lumen. For short vertical sections, IMU-based dead reckoning, integrated forward from previous orientations, can be used.

The electronics and battery 157 can include memory for storing sensed data and can include wireless communications for communicating with electronics outside of the lumen during an inspection. The electronics and battery 157 are also used for voltage regulation and motor control and feedback computations and trajectory planning, and preferably include a high-capacity lithium polymer battery that powers the robot 100.

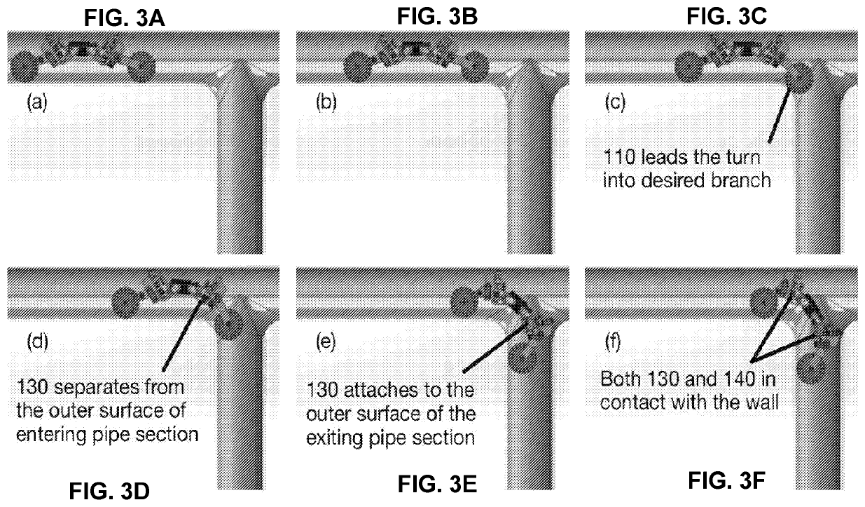

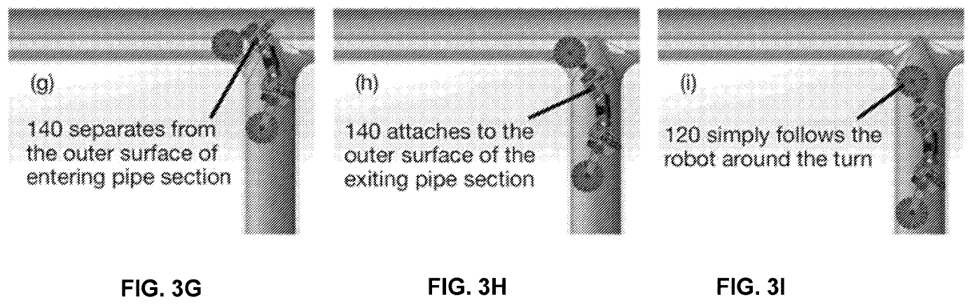

FIGS. 3A-3F show the robot 100 negotiating an intersection of two lumens, such as two pipes including a main pipe and a branch pipe. FIGS. 3A-3B show the robot 100 approaching a branch with the drive wheel 110 leading. Control is conducted to allow the arm 160 to have the wheel 110 travel into the branch in FIG. 3C. The robot could instead go past the branch by maintaining the arm 160 in the position of FIGS. 3A-3B. Control is conducted to shorten the robot as it turns into the branch such that the control wheel 130 first loses contact in the main lumen (FIG. 3D) and then contacts a wall of the branch lumen (FIG. 3E-3F). FIG. 3F shows the middle portion of the turn procedure, after which the robot will begin to lengthen and the trailing drive wheel and control wheel will enter the branch lumen. During the turning procedure, at least three alternating points of contact with the pipe wall are maintained throughout this entire maneuver. The springs 183 and 193 provide enough force such that drive wheels 110 and 120 both maintain their outward normal force against the lumen wall, and thus their traction along the =wall, throughout the entire maneuver, regardless of the direction of gravity. Even if one of the drive wheels slips at some point through the maneuver, which is possible if the radius of the turn at the T joint is especially sharp, the other drive wheel still maintains substantial outward normal force directly against the pipe wall due to the torque applied by one of the springs, and thus maintains sufficient traction to drive the robot around the corner.

With regard to the turning, control is conducted such that partway into the turn (FIG. 3D), control wheel 130 is moved to separate off the outer side of the pipe wall of the main (entering) lumen section. Shortly after, the control wheel 130 establishes contact with the lumen wall in the branch (exiting) lumen section while the control wheel 140 is in contact with the main lumen wall in FIGS. 3E and 3F. After the halfway point of the turning, the control wheel 140 is controlled to separate from the wall of the main lumen (FIG. 3G. As movement into the branch continues, the control wheel 140 makes contact with the lumen wall of the branch (FIG. 3H). Fully in the branch lumen, the axial profile of the robot is re-established (FIG. 3G) and it can continue to travel axially and rotate within the branch lumen. The control can be very simple, as appropriate coordination of the actuators 104 can be simply to keep difference of the nominal angles at the two arms 150 and 160 close to zero, while ensuring that a separation and re-establishing of contact of control wheels 130 and 140 from/to the lumen wall in negotiating the turn follows the steps in FIGS. 3A-3I. Control is conducted to ensure that the frame 150 turns at the appropriate rate through the turn such the frame does not contact lumen walls.

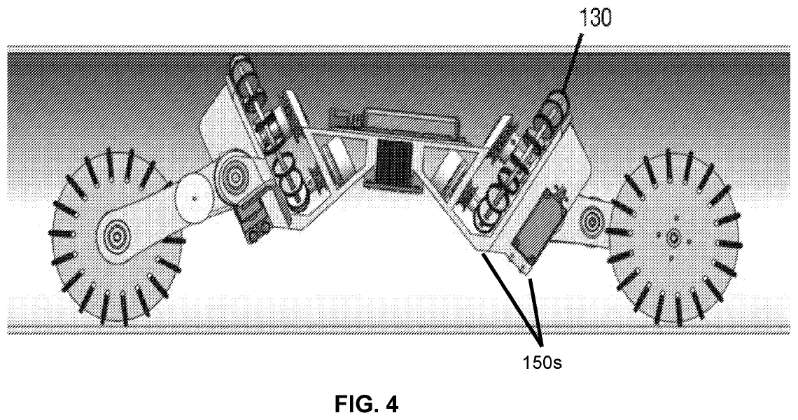

FIG. 4 shows another operational state of the robot 100 in which one of the control wheels 130 is out of contact with the lumen wall. This can be used purposely during axial travel, for example, to avoid or limit interactions with irregularities in the lumen wall. This can also provide a small reduction in the amount of frictional resistance to travel. The frame 150 also includes one or more smooth surfaces 150s that are useful in the event of failure of a spring, arm motor or wheel such that dragging resistance is limited should the other drive and control wheels need to move the robot when the other drive or control wheel or arm has failed. Preferably, all surfaces of the frame 150 includes smooth, low-friction edges, or at least any surface that could contact a lumen wall during robot operation or a partial failure of an arm, motor, wheel, etc.

For example, in the event of failure of control wheel 130 or motor 131 or belt/pulley assembly 132, the control wheel 130 can be disengaged using servo motor 181 to separate the failed control wheel from the lumen wall. Similarly, in the event of failure of control wheel 140 or motor 141 or belt/pulley assembly 142, the control wheel 140 can be disengaged from the lumen wall using the servo motor 191. Either of the drive wheels can also be disengaged by driving the servo motors 181 or 191 further. Basically, any of the drive or control wheels can be disengaged for operation or in the case of failure.

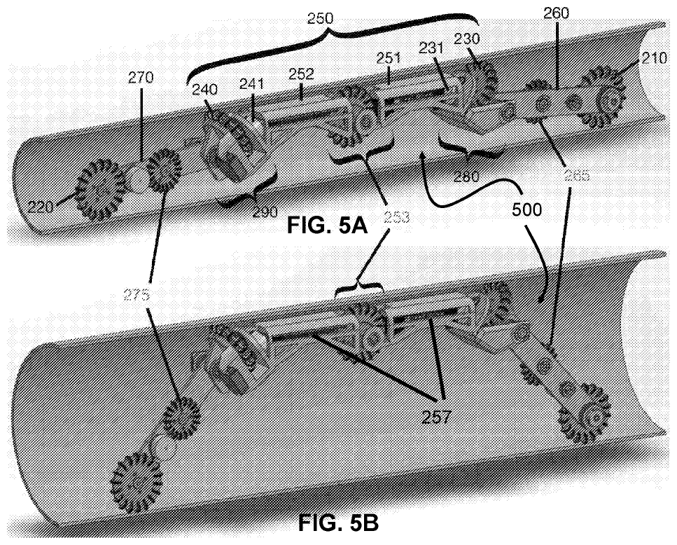

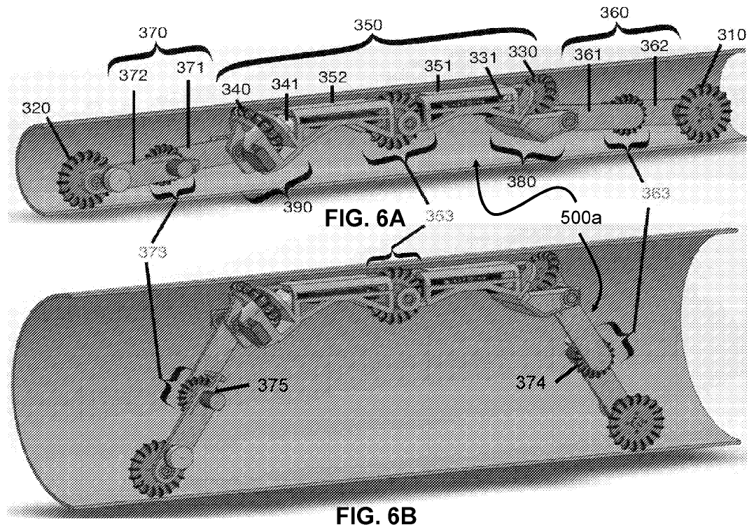

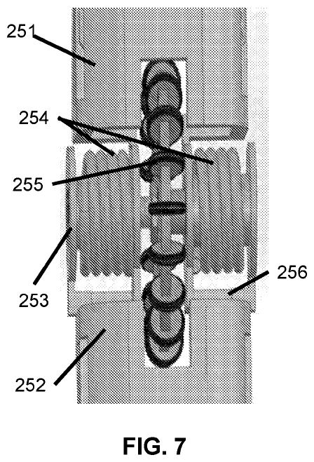

FIGS. 5A and 5B show another robot 500 that includes a different frame and additional wheels. FIGS. 6A and 6B show modified robot 500a that includes additional articulation features compared to the robot 500 of FIGS. 5A and 5B. FIGS. 7A-7FH illustrate common features of the robots 500 and 500a of FIGS. 5A-6B. The robots 500 and 500a can use features described with respect to the robot 100 for drive wheels, control wheels and arms, including motors, drive plates, springs, etc., as will be appreciated by artisans.

The robot 500 includes a front drive wheel 210 and a back drive wheel 220, as well as a front control wheel 230 and a back control wheel 240. A motor 231 controls rotation of the control wheel 230 and a motor 241 of the back control wheel. A robot frame 250 includes front 251 and back 252 sections with an articulation 253 between the front 251 and back 252 sections.

As seen in FIG. 7, coil springs 254 are concentric with a passive, undriven idler wheel 255 and a physical stop 256 limits the angular range of the front 251 and back sections 252. Referring again to FIGS. 5A-5B electronics, battery and sensors 157 are carried in and/or on one or both of the front 251 and back 252 sections. A front robot arm 260 includes an idler wheel 265 in its approximate or exact center. A back robot arm 270 includes an idler wheel 275 in its approximate or exact center. Servo motors 280 and 290 for the arms 260 and 270 can be the same as the series elastic actuators 104 of the robot 100.

The coil spring 254 applies bias to align the body sections 251 and 252 into a common plain, which is the position when the physical stop 256. This position is used during normal robot operation when travelling along an axis of a lumen and when rotating within the lumen. During turning, halfway through an elbow or joint in a particularly narrow pipe, the turning is the same as the robot 100, except that the idler wheel 255 may come in contact with the inner portion of the lumen wall. At this point, articulation 253 permits an angle to form between body sections 251 and 252, which aids the robots 500 and 500a during a turn into a branch lumen. The idler wheels 265 and 275, may come in contact with the inner lumen wall when turning, and further allow the robots 500 and 500a to maneuver more smoothly through narrow pipe elbows and pipe joints.

The robot 500a of FIGS. 6A-6B is a variation of the robot 500 and includes additional articulations 363 and 373 in the robot arms 360 and 370. The robot includes the front drive wheel 310 and back drive wheel 320. The front control wheel 330 is driven by a motor 331, which can have its shaft directly drive the control wheel 330. A back control wheel 340 is driven similarly by a motor 341. The frame 350 includes front 351 and back 352 sections on opposite side of an articulation 353, which is constructed in the same manner as in FIG. 7. The biased articulations 363 and 373 are also constructed in the same way and respectively separate the arms 360 and 370 into sections 361 and 362 and 371 and 372. Idler wheels 374 and 375 are included about the articulations 363 and 373.

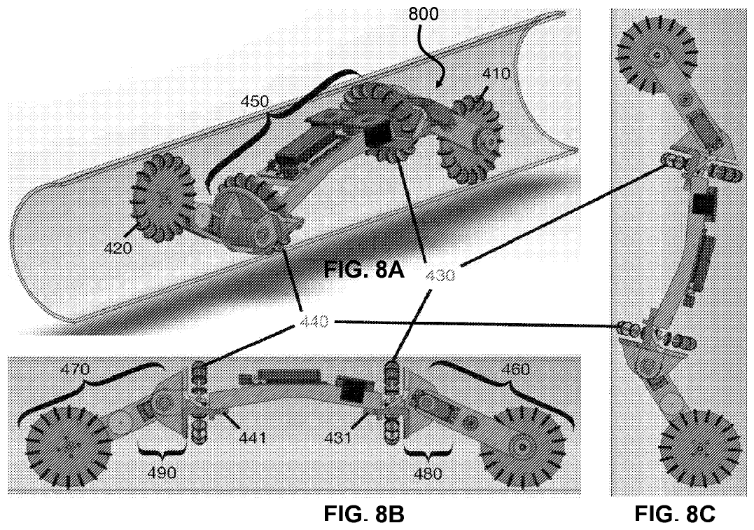

FIGS. 8A-8C show a robot 800 that is similar to the robot 100 but has control wheels 430 and 440 that have an angle phi of zero from vertical. The robot 800 can use features described with respect to the robot 100 for drive wheels, control wheels and arms, including motors, drive plates, springs, etc., as will be appreciated by artisans. It can also incorporate articulations and idler wheels in accordance with the robots 500 and 500a, as will be appreciated by artisans. Features that are labelled in FIGS. 8A-8C include the front and back drive wheels 410 and 420, the front control wheel 430 and its motor 431, and the back control wheel 440 and its motor. Also indicated are the body 450, arms 460 and 470 as well as the elastic series actuators 480 and 490. In the robot 800, the servo motors 481 and 491 can be fixedly attached to the arms 460 and 470 and thereby drive relative rotation with respect to the frame 450, instead of mounting the motors to the frame as in the robot 100. The robot 800 with phi=0, facilitates vehicle operation in both the C Profile shown in FIG. 8B discussed with respect to the robot 100, as well as a Z Profile (see FIGS. 8A and 8C), with the four robot wheels touching the pipe wall at four alternating points of contact, thus providing improved traction in a vertical lumen as shown in FIG. 8C.

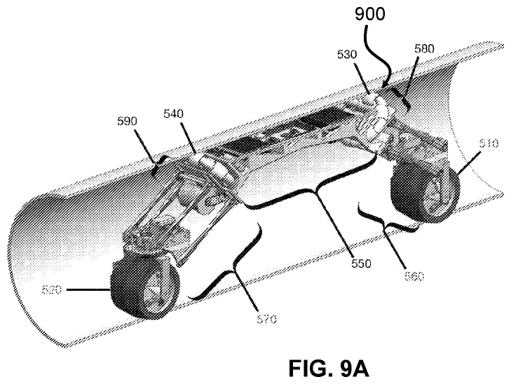

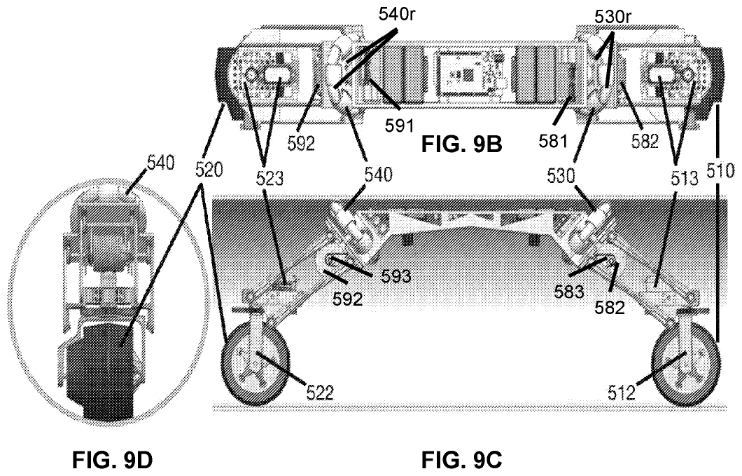

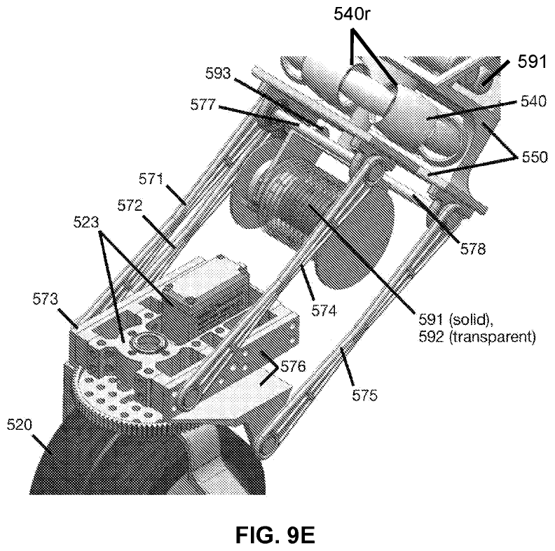

FIGS. 9A-9E show another robot similar to the robot 100 but using a different type of frame and different wheels. Apart from the frame and wheels, the robot 900 can use any one or combination of the features described above. The drive wheels 510 and 520 are electric skateboard style wheels that include their own motors and can be controlled via wiring by the robots electronics (see above description for electronics and sensors carried by the robots). Control wheels 530 and 540 have an exemplary phi angle of 45 degrees, and include wider roller rings 530r and 540r, forming omni wheels as discussed above. Arms 560 and 570 are formed from four bars, arranged to keep axles of the drive wheels 510 and 520 generally orthogonal to a contact patch on a lumen wall. Series elastic actuators 580 and 590 operate as described above. Brackets 512 and 522 respectively rotationally mount the drive wheels 510 and 520.

As seen in FIGS. 9B-9D and the partial view of the arm 570 in FIG. 9E, the brackets 512 and 522 are gimballing brackets configured to turn the drive wheels 510 and 520 during a roll. Servo motor assemblies 513 and 523 control the rotation of the drive wheel 520. With reference to FIG. 9E, the arm 570 is illustrative also of the components of the arm 560. The four bars that form the arm 570 include upper bars 571 and 574, lower bars 572 and 575. End portions of the gimbal end structure 573 and 576 respectively connect to the lower bars and upper bars. At their opposite end, the upper and lower bars connect to synchronization bars 577 and 578.

Features shown in FIGS. 9B-9E include motors 581 and 591 mounted to the body 550 that drive coil springs 582 and 592 via chain/gear assemblies 583 and 593 to raise and lower the arms 560 and 570, with the springs 582 and 592 maintaining bias to keep the drive wheels 510 and 520 and control wheels 530 and 540 pressed against lumen walls opposite one another. With the robot 900, roll control is different than with the robot 100. Roll control is conducted by simultaneous turning and driving the drive wheels 510 and 520.

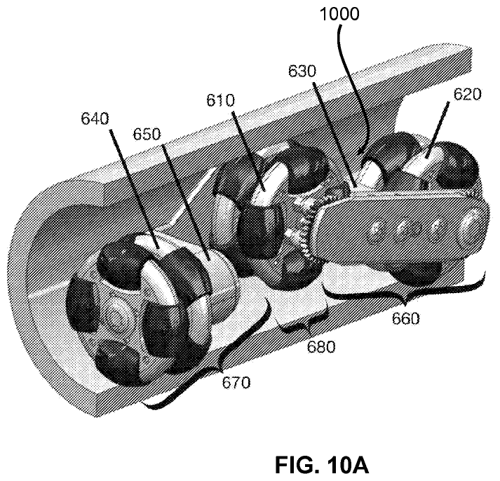

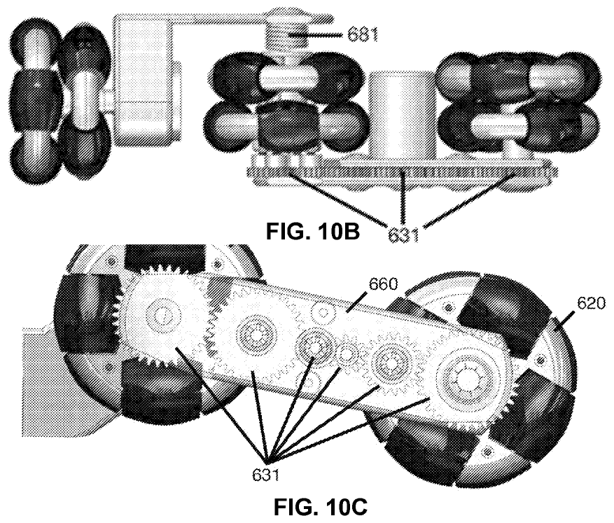

FIGS. 10A-10C show another robot 1000 similar to the robot 100. Apart from the frame, the robot 1000 can use any one or combination of the features described above with respect to the robots other than the wheels and arms of the robot 900. The robot 1000 includes a central drive wheel 610 that is concentric with an articulation 680. An end/front drive wheel 620 is mounted on arm 660. A motor assembly 630 (which can also house electronics and provide mounts for sensors as discussed above) drives the drive wheels 610 and 620 through a gear assembly 631 that can be enclosed in the arm 660, which forms a housing for the gear assembly 631. The articulation is biased by concentric spring 681 to keep the drive wheels 610 and 620, as well as a control wheel 640 in contact with lumen walls. A motor 650 drives the control wheel 640. The drive wheels and control wheel can be dual wheels for more traction, and with the dual wheels a plane passes through the center of the control wheel, and the rotational center of the central and end drive wheels is through an axis midway between the two wheels.

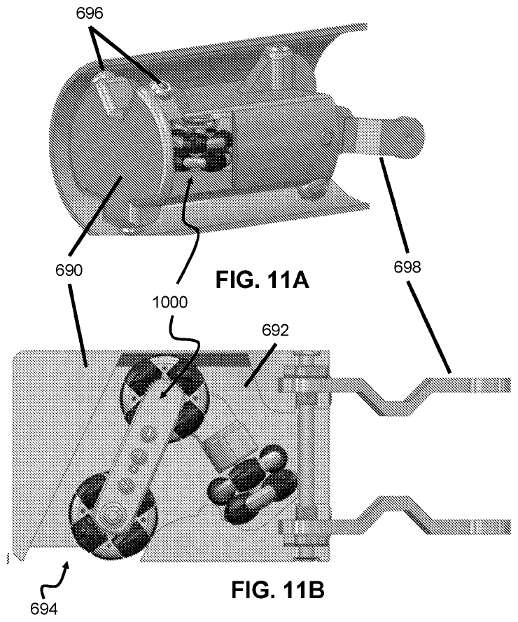

FIGS. 11A-B show that the robot 1000 can be transported in a generally cylindrical transport module 690. The module has a shaped cavity 692 that is configured to accommodate the robot 1000 in a folded position shown in 11B. The cavity 692 has an opening 694 that allows the robot 1000 to enter and leave the module 690. Bearings 696 permit the module to be towed behind a robot with the trailer hitch 158 and attachment bar 159 by a trailer link 698 on one end of the transport module. In the transport module 690, the robot 1000 is carried as a “marsupial robot,” and towed behind a larger robot, such as a robot 100 configured to be large. The robot 1000 can be deployed/retrieved as needed on short sorties targeting the exploration and inspection of small-diameter pipes, e.g. small pipes (leading, e.g., to individual customers in gas distribution networks) from larger main pipes (buried, e.g., under streets in a city). To turn through an elbow joint, the robot 1000 first rolls such that its center plane contains the curved centerline of the joint, in a manner similar to that illustrated in FIGS. 3A-3I.

Robots of the invention can be sized to inspect many lumens, such as water, gas, & sewer lines, as well as HVAC ducts. Robots of the invention can bring important inspection technologies such as LiDAR (Light Detection And Ranging—that is, depth revealing) camera systems, IMUs (Inertial Measurement Units—that is, tiny accelerometers, gyroscopes, and magnetometers), GPS (Global Positioning System), vision-based SLAM (Simultaneous Localization And Mapping) algorithms, automatic feature detection in images using modern Al/ML (Artificial Intelligence/Machine Learning) algorithms, etc] to the internal inspection, exploration, and mapping of complex pipe networks that normal robots can't navigate. Present robots have a physical design that can actually maneuver reliably through large networks of pipes containing elbows of various bending radii, joints of various types, substantial diameter changes, and vertical pipe sections. The robots can navigate within lumens that can have puddles of water, sludge, sewage, or debris collected in their lower portion, via the ability to first rotate a low-blockage, essentially planar inspection robot to horizontal, to safely pass over such potential obstructions. Similarly, the present robots can navigate through corroded lumens, and lumens including irregularities and objects on portions of their walls.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A lumen network inspection robot comprising:
at least two drive wheels configured to propel the robot in an axial direction of the lumen;
at least one control wheel configured to control roll of the robot around an axial centerline of the lumen;
one or more motors are arranged to drive the at least two drive wheels;
a body structure including one or more arms supporting the at least two drive wheels and the at least one control wheel;
bias elements that bias the at least two drive wheels and the at least one control wheel toward contact with at least three alternating points on a wall of the lumen;
control electronics configured to control the one or more motors; and
one or more sensors; wherein rotational centers of the at least two drive wheels and the at least one control wheel lie in a common plane.

2. The lumen network inspection robot of claim 1, wherein the common plane extends through a center of the body structure.

3. The lumen network inspection robot of claim 1, wherein the body structure comprises a body and two arms on opposite sides of the body, and wherein the at least two drive wheels are mounted on different ones of the two arms to rotate in parallel to the common plane, and wherein the at least one control wheel is mounted to the body to rotate on a vertical plane that passes through an axial center line of the lumen.

4. The lumen network inspection robot of claim 3, wherein the vertical plane is perpendicular with respect to the axial centerline of the lumen.

5. The lumen network inspection robot of claim 3, wherein the vertical plane is canted from perpendicular with respect to the axial centerline of the lumen.

6. The lumen network inspection robot of claim 1, comprising one or more articulations in the body structure.

7. The lumen network inspection robot of claim 6, wherein the one or more of the articulations comprises a central articulation and arm articulations.

8. The lumen network inspection robot of claim 1, wherein the at least one control wheel comprises an omni wheel.

9. The lumen network inspection robot of claim 1, wherein the at least two drive wheels comprise omni wheels.

10. The lumen network inspection robot of claim 1, wherein the at least two drive wheels comprise gimballed wheels.

11. The lumen network inspection robot of claim 1, comprising a trailer hitch.

12. The lumen network inspection robot of claim 1, wherein the body structure comprises a body and two arms on opposite ends of the body, wherein the at least one control wheel comprises two omni wheels mounted on the body where the arms are joined to the body to rotate on a vertical plane that passes through an axial center line of the lumen, and wherein at least two drive wheels are two drive wheels mounted at ends of the two arms.

13. The lumen network inspection robot of claim 12, comprising two series elastic actuators to control a position of the arms, wherein the bias elements comprise a spring in each of the two series elastic actuators that bias the two omni wheels and the two drive wheels away from one another to maintain contact with lumen walls in the absence of active control by motors in the two series elastic actuators.

14. The lumen network inspection robot of claim 13, wherein the two series elastic actuators each comprise a motor, a shaft through a center of a spring, and an output plate attached to the springs, the output plate being configured to drive rotation of the arms.

15. The lumen network inspection robot of claim 13 wherein the at least two drive wheels comprise omni wheels.

16. The lumen network inspection robot of claim 1, wherein the at least two drive wheels comprise a central drive wheel and an end drive wheel, wherein the central drive wheel is mounted on an articulation, and the end drive wheel on a first arm extending from the articulation, and where the at least one control wheel is mounted on a second arm extending from the articulation.

17. The lumen network inspection robot of claim 16, wherein the central drive wheel, the end drive wheel and the at least one control wheel comprise omni wheels.

18. The lumen network inspection robot of claim 16, wherein the bias elements comprise a coil spring around the articulation configured to bias the central drive wheel away from the end drive wheel and the at least one control wheel.

19. The lumen network inspection robot of claim 16, wherein the first arm comprise a gear system and motor to drive the central drive wheel and the end drive wheel, and the second arm comprises a motor to drive the at least one control wheel.

20. The lumen network inspection robot of claim 1, comprising a battery to power the one or more motors.

21. The lumen network inspection robot of claim 1, comprising a tether configured to deliver power to the one or more motors.
